(19) United States
(12) Patent Application Publication
(10) Pub. No.: US 2010/0309087 A1
(43) Pub. Date: Dec. 9, 2010

(54) Chip antenna device

(75) Inventors: Yueh-Lin Tsai, Yunlin County (TW); Sheng-Kai Wen, Kaohsiung City (TW); Chih-Wei Chen, Miaoli County (TW)

Correspondence Address: BACON & THOMAS, PLLC, 625 SLATERS LANE, FOURTH FLOOR, ALEXANDRIA, VA, 22314-1176, US

(73) Assignee: INPAQ TECHNOLOGY CO., LTD., Hsinchu (TW)

(21) Appl. No.: 12/457,229

(22) Filed: Jun. 4, 2009

(51) Int. Cl. H01Q 1/38; H01Q 1/50

(52) U.S. Cl. 343/861; 343/700 MS

(57) ABSTRACT

A chip antenna device includes a single or multi-layer dielectric substrate, a radiator body, one or a plurality of first coupling electrodes formed on the radiator body, and a ground radiator formed on the upper or lower surface or inter-layer in another end of the substrate. It is designed by using loops and coupling concepts. The chip antenna device does not require large areas and clear space but has high radiation efficiency. It adjusts the impedance matching and operation frequency by changing the signal feed position, so that low frequency operation can be achieved without increasing the area of said antenna meeting the requirements of compact size for electronic products.

### BACKGROUND OF THE INVENTION

1. Field of the invention

The present invention relates to a chip antenna device, particularly to an antenna designed by using loops and coupling concepts. The chip antenna device does not require large areas and clear space but has high radiation efficiency. It adjusts the impedance matching and operation frequency by changing the signal feed position, so that low frequency operation can be achieved without increasing the area of said antenna meeting the requirements of compact size for electronic products.

2. Description of the Prior Art

Accordingly, with the rapid development of wireless communication industry, a variety of electronic devices, i.e. mobile phones, computers and networks, are equipped with the function to achieve signal transmission using wireless communication. The major radiating and receiving device for wireless communication is the signal transmitting and receiving device and antenna mounted thereon. Antennas will become a critical element due to wide applications of wireless communication. In order to reduce the manufacturing cost of antennas and meet design requirements of thinness and compactness, traditional antennas (i.e. rod antenna, Yagi antenna, dish antenna, etc.) cannot meet the demands in new age. At present, wireless communication products have been developed toward miniaturization. Specifically, chip antenna is one type of antennas developed in recent years and undoubtedly will give a boost to the development of wireless communication.

However, most of chip antennas mounted on a variety of electronic products re quire additional, sufficient clear space to bring radiation into practice. Moreover, such antenna only has single frequency operation capability and cannot meet requirements of multi-frequency operation so that its workability is limited.

### SUMMARY OF THE INVENTION

Accordingly, the chip antenna device in the present invention has been developed to solve the above-mentioned problems occurring in the prior art.

A purpose of the present invention is to provide a chip antenna device which can adjust the feed position, by way of adjusting the signal feed pointing order to determine the impedance and operation frequency. Also, the ground radiator can be viewed as a part of the antenna by means of coupling. The impedance and operation frequency can be adjusted by way of changing the coupling. Accordingly, the antenna can be operated in such structure with limited space while high efficiency can be maintained and minimization can be achieved.

Another purpose of the present invention is to utilize multi-signal feeding by means of the identical antenna structure to achieve small area, high efficiency and multi-frequency operation.

According to the purposes above, the chip antenna device in the present invention includes a single or multi-layer dielectric substrate; a radiator body formed on the upper or lower surface or inter-layer of one end of the substrate wherein one end of said radiator body extends toward the center of said substrate forming an impedance matching branch and bent and extended to the end surface of said substrate to connect with a feed signal connector; one or a plurality of first coupling electrodes are formed on said radiator body; a ground radiator formed on the upper or lower surface or inter-layer of another end of the substrate wherein said ground radiator and a radiator body are aligned in parallel and one end of said ground radiator is ground terminal extending to the end surface of the substrate; one or a plurality of second coupling electrodes are formed on the ground radiator; said second coupling electrode and first coupling electrode face with each other leading to coupling effects. Accordingly, the impedance matching and operation frequency can be adjusted by way of adjusting the distance between a feed signal connector and a ground terminal and the distance between the first coupling electrode and second coupling electrode. Therefore, the antenna can be operated in high efficiency without large clear space and increased volume. Meanwhile, utilizing similar antenna structure using multi-signal feeding can also achieve small area, high efficiency and multi-frequency operation.

The structure, features, functions, effects and purposes of the present invention will be more apparent from the following descriptions taken in conjunction with the accompanying drawings.

### BRIEF DESCRIPTION OF THE DRAWINGS

FIG. 1 is a three-dimensional external view of the chip antenna device in the present invention.

FIGS. 2A to 2G are diagrams of chip antennas in each embodiment of the present invention.

FIG. 3 is a diagram showing dual frequency and dual-fed of the chip antenna device in the present invention.

FIGS. 4A to 4C are diagrams of the electric characteristics and the input impedance of the chip antenna device in the present invention.

FIG. 5 is a three-dimensional diagram showing the radiation pattern of the chip antenna device in the present invention.

FIG. 6 is another diagram showing dual-frequency and single-fed chip antenna device in the present invention.

### DETAILED DESCRIPTION OF THE PREFERRED EMBODIMENTS

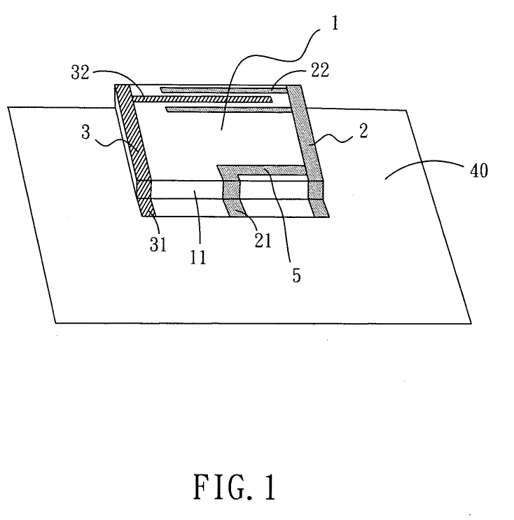

The present invention relates to a chip antenna device, referring to FIG. 1, the chip antenna device in the present invention includes a dielectric substrate 1, a radiator body 2 and a ground radiator 3; wherein the dielectric substrate 1 can be a single or multi-layer dielectric substrate; the radiator body 2 is formed on the upper or lower surface or inter-layer of one end of the substrate 1 wherein the radiator body 2 is at least partially connected to ground and one end of said radiator body 2 extends toward to the center of said substrate 1 forming an impedance matching branch 5 and bent and extended to the end surface of the substrate to connect with the feed signal connector 21; one or a plurality of first coupling electrodes 22 are formed on the radiator body 2; the ground radiator 3 is formed on the upper or lower surface or inter-layer of another end of the substrate 1, and is parallel to radiator body 2; one end of the ground radiator 3 is ground terminal 31 which extends to end surface 11 of said substrate; one or a plurality of second coupling electrodes 32 are formed on the ground radiator 3.

The first coupling electrode 22 of the radiator body 2 is not in direct contact with the second coupling electrode 32 of the ground radiator 3 and there is an equal distance between the two electrodes. When the feed signal connector 21 and ground terminal 31 are connected to the circuit board 40 of an electronic device to form a closed loop, a coupling effect (i.e. C≈∈A/d) which is equivalent to the capacitance may occur between the first coupling electrode 22 and second coupling electrode 32. The coupling effect is inversely proportional to the distance between the two electrodes but is directly proportional to the area between the two electrodes. Accordingly, the coupling effect occurs when adjusting the distance and area between the two electrodes.

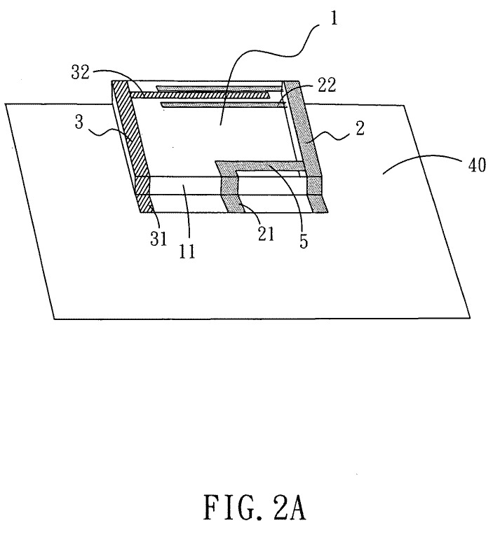

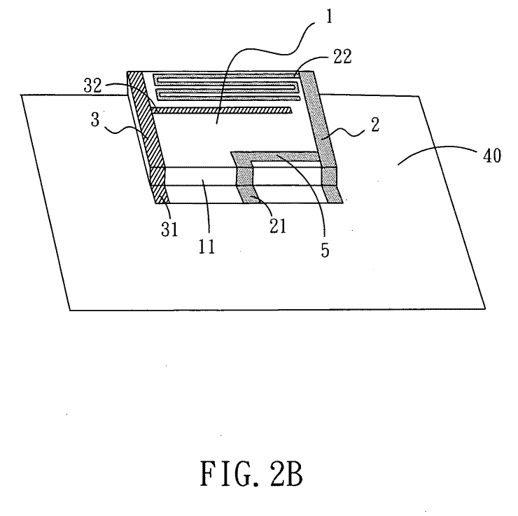

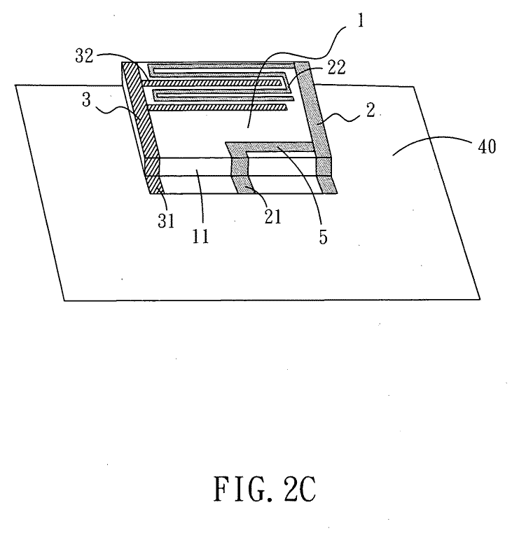

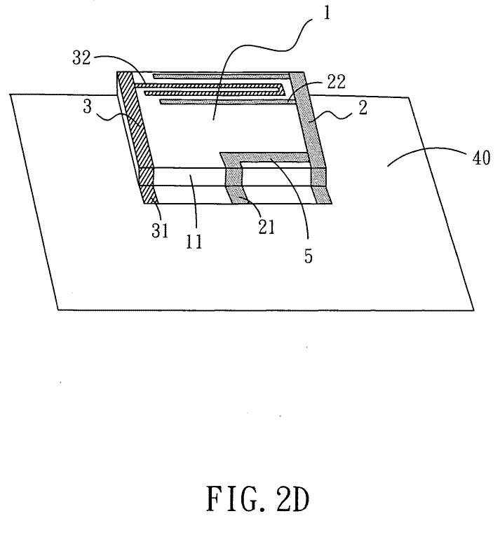

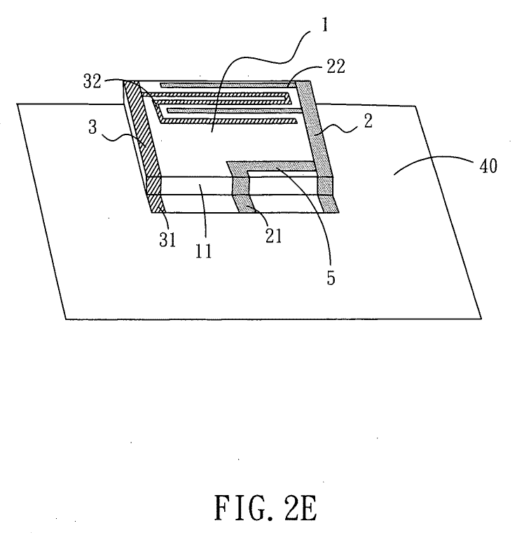

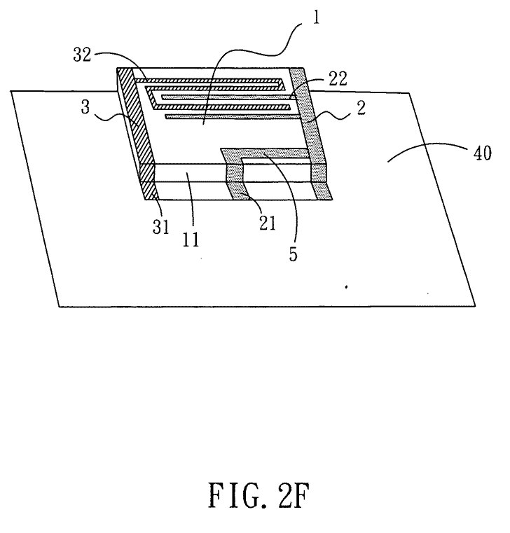

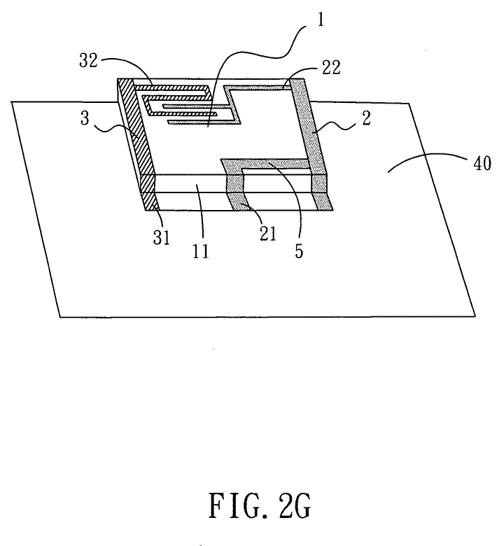

Referring to FIGS. 2A to 2G, in the embodiments of the present invention, the first coupling electrode 22 and second coupling electrode 32 can be placed at the relative positions in different planes respectively. The coupling effect also occurs by way of adjusting the distance or area between the two electrodes (as shown in FIG. 2A). Also, the first coupling electrode 22 can be successfully bent in shape with its length and current path increased. The first coupling electrode 22 and second coupling electrode 32 are put in the relative positions so that coupling effects may occur by way of adjusting the distance or area between the two electrodes (as shown in FIGS. 2B and 2C). Also, the second coupling electrode 32 can be successfully bent in shape with its length and current path increased. The first coupling electrode 22 and the second coupling electrode 32 are put in the relative positions so that coupling effects may occur by way of adjusting the distance or area between the two electrodes (as shown in FIGS. 2D, 2E, and 2F). Moreover, the first coupling electrode 22 can be successively bent or in a dendritic shape, while the second coupling electrode 32 can also be successively bent or in a dendritic shape. However, the two are placed in relative positions so that coupling effects occurs when the distance or area between the two electrodes are adjusted (as shown in FIG. 2G).

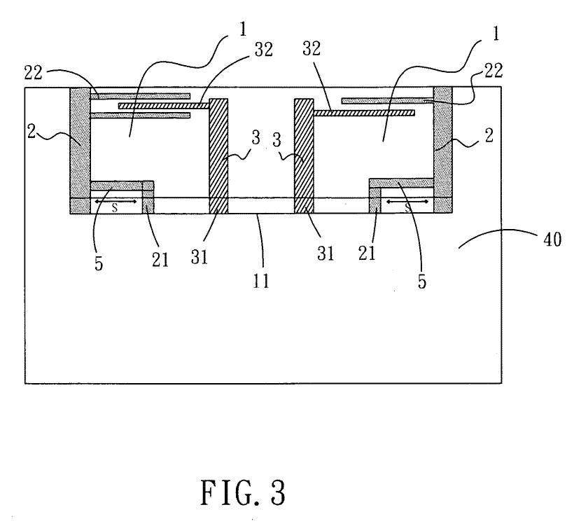

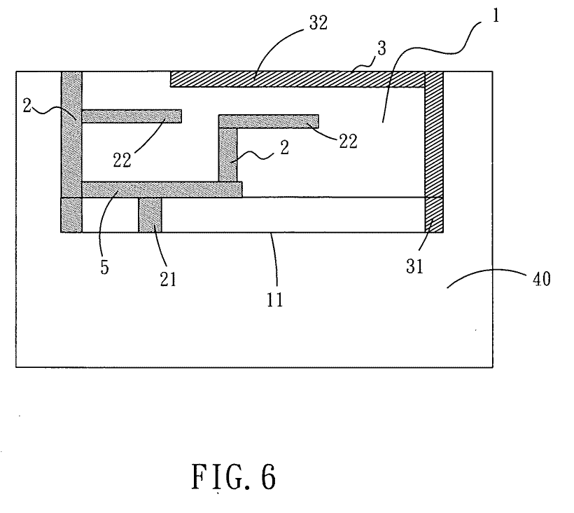

Referring to FIGS. 3 and 6, in the embodiments of the present invention, the radiator body 2 and ground radiator 3 on the substrate 1 can be extended so that two or more sets of identical radiator bodies 2 and ground radiators 3 can be formed on the same substrate 1, with a plurality of feed signal connectors 21 and a plurality of ground terminals 31, wherein the feed signal connectors 21 can adopt single, dual, or multiple resonant frequencies to obtain the effects of dual or multi-frequency operation. The multi-band chip antenna is also characterized in the small area and high efficiency and there is good isolation among feed signals. Taking dual-frequency (including single-fed dual-frequency and dual-fed dual-frequency) for example, the feed signal connector 21 of the radiator body 2 is not in direct contact with the ground terminal 31 of the ground radiator 3 but there is an equal distance between the feed signal connector 21 and ground terminal 31. When the feed signal connector 21 and ground terminal 31 are connected to the circuit board 40 of an electronic device to form a closed loop, a coupling effect (i.e. C≈∈A/d) that is equivalent to capacitance may occur between the feed signal connector 21 and ground terminal 31. The coupling effect is inversely proportional to the distance between the feed signal connector 21 and ground terminal but is directly proportional to the area between the feed signal connector 21 and ground terminal 31.

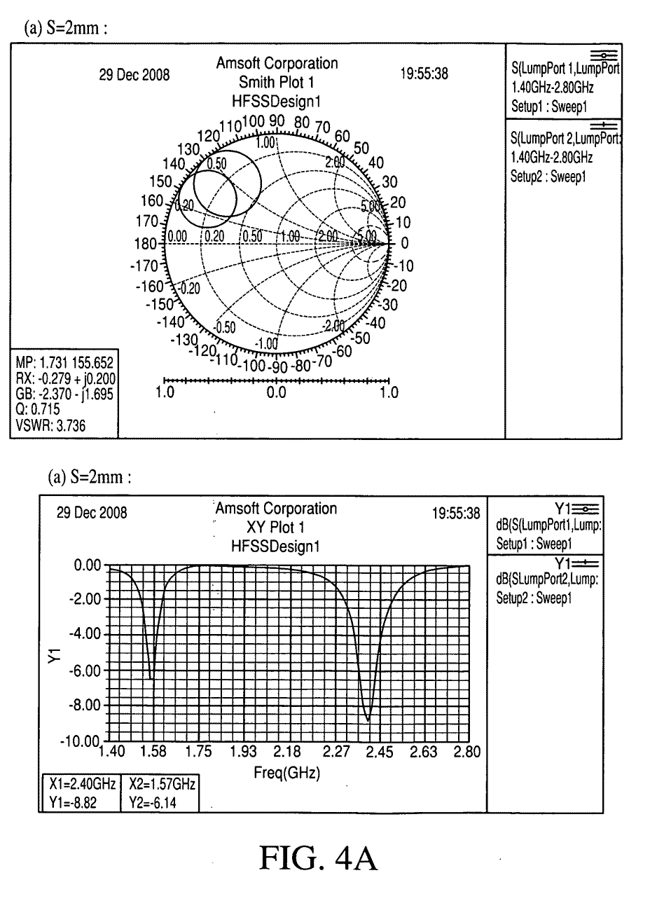

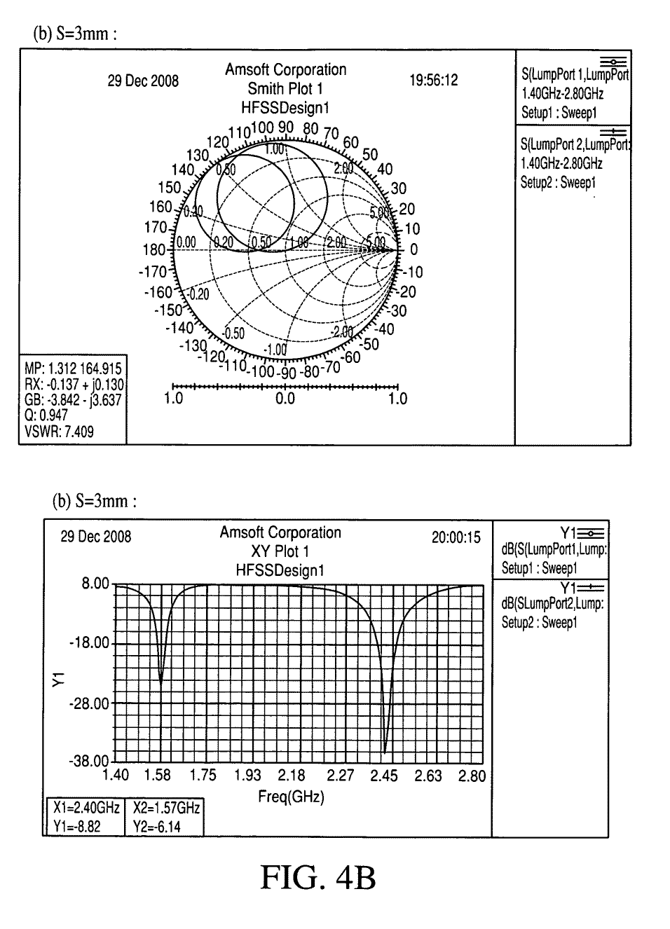

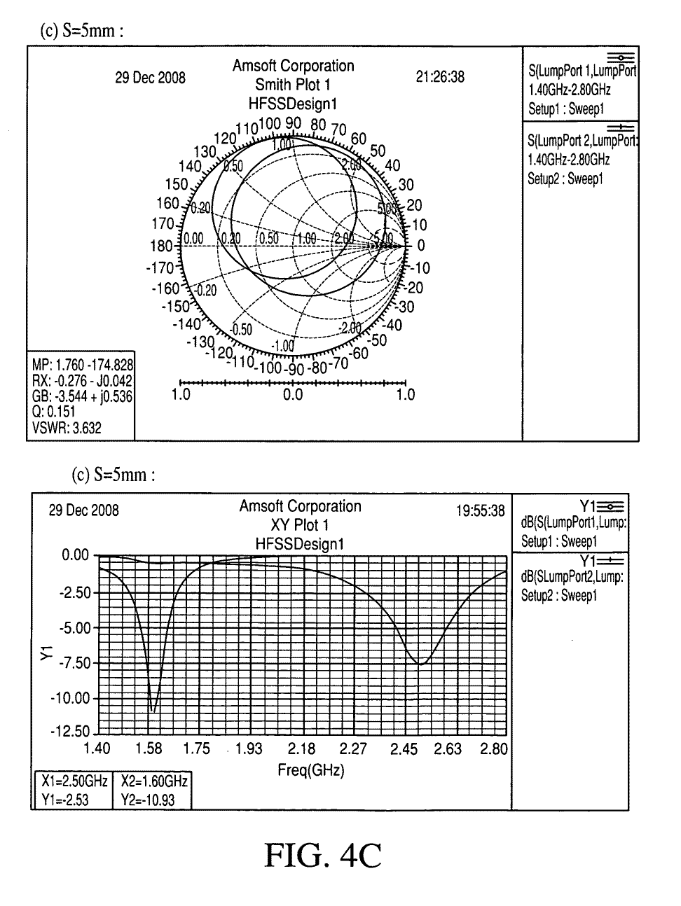

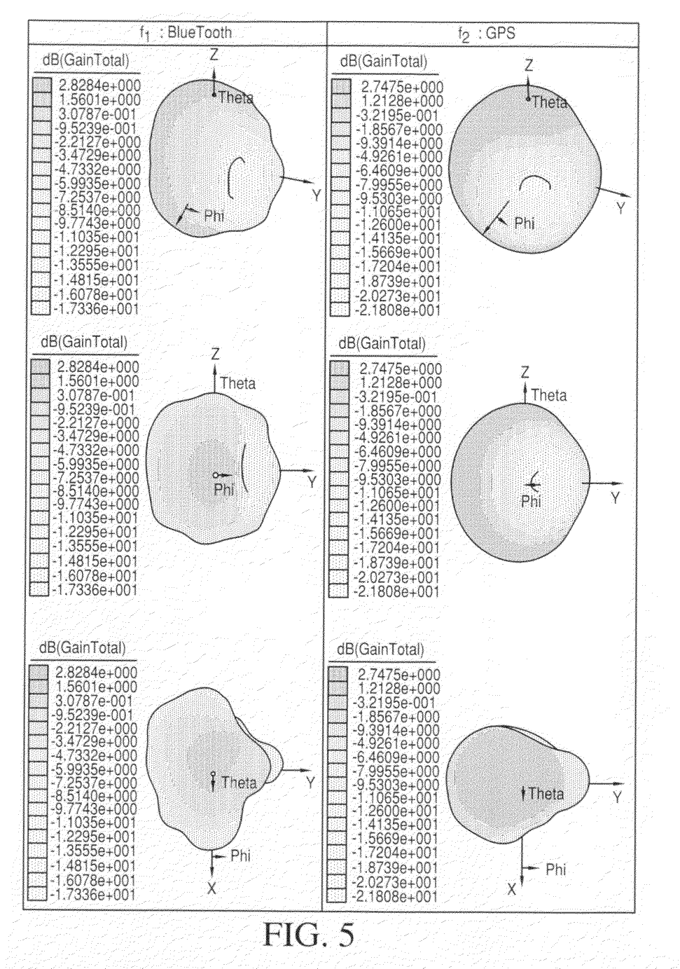

As shown in FIGS. 4A, 4B, and 4C, impedance matching and operation frequency can be adjusted with the change of the distance S between the feed signal connector 21 and radiator body 2 (i.e. adjusting the distance between the feed signal connector 21 and ground terminal 31). When S=2 mm, the input impedance is located in the upper left: corner of the Smith Chart, far away from the center, while the return loss is greater (as shown in FIG. 4A). With the increase of the distance S (2 mm→3 mm→5 mm; that is, the distance between the feed signal connector 21 and ground terminal 31 is decreased), the small circle in the upper left corner of the Smith Chart gradually moves toward the lower right side and is enlarged (as shown in FIGS. 4B and 4C) The closer it gets to the center, the smaller the reflection coefficient will be. As shown in FIG. 5, when an electronic device is equipped with Bluetooth and GPS (global positioning system), the impedance close to a center point can bring out a 3D radiation on Bluetooth and GPS. By changing the position of the feed signal connector 21 and adjusting the distance or area between coupling electrodes, the chip antenna with a demanded frequency for a variety of electronic devices can be designed.

From what is described above, the chip antenna device in the present invention has not yet been made public, which is consistent with relevant Patent Law.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A chip antenna device, comprising:
a single or multi-layer dielectric substrate;
a radiator body formed on the upper or lower surface or inter-layer of one end of said substrate wherein said radiator body is at least partially connected to ground and one of its ends extends toward to the center of said substrate forming an impedance matching branch and is bent and extended to the end surface of said substrate to connect with the feed signal connector; one or a plurality of first coupling electrodes are formed on the radiator body;
a ground radiator formed on the upper or lower surface or inter-layer of another end of said substrate wherein one end of said ground radiator is a ground terminal extending to the end surface of said substrate; one or a plurality of second coupling electrodes are formed on the ground radiator; the second coupling electrode and first coupling electrode face each other leading to coupling effects; and
the impedance matching and operation frequency can be adjusted by way of adjusting the distance between the feed signal connector and ground terminal and the distance or area between the first coupling electrode and second coupling electrode.

2. The chip antenna device according to claim 1, wherein said first coupling electrode and second coupling electrode can be put in the relative positions in different planes.

3. The chip antenna device according to claim 1, wherein said first coupling electrode can be successively bent in shape with its length and current path increased.

4. The chip antenna device according to claim 1, wherein said second coupling electrode can be successively bent in shape with its length and current path increased.

5. The chip antenna device according to claim 1, wherein said first coupling electrode can be successively bent or in a dendritic shape.

6. The chip antenna device according to claim 2, wherein said first coupling electrode can be successively bent or in a dendritic shape.

7. The chip antenna device according to claim 3, wherein said first coupling electrode can be successively bent or in a dendritic shape.

8. The chip antenna device according to claim 4, wherein said first coupling electrode can be successively bent or in a dendritic shape.

9. The chip antenna device according to claim 1, wherein said second coupling electrode can be successively bent or in a dendritic shape.

10. The chip antenna device according to claim 2, wherein said second coupling electrode can be successively bent or in a dendritic shape.

11. The chip antenna device according to claim 3, wherein said second coupling electrode can be successively bent or in a dendritic shape.

12. The chip antenna device according to claim 4, wherein said second coupling electrode can be successively bent or in a dendritic shape.

13. The chip antenna device according to claim 1, wherein said impedance matching branch is the part extended from said radiator body which can wholly or partially or wholly not be disposed on the dielectric substrate and can be implemented on a circuit board.

14. The chip antenna device according to claim 1, wherein the radiator body and ground radiator on said substrate can be extended, and two or more sets of similar radiator body and ground radiator can be formed in the same substrate so that a multi-frequency, multi-fed chip antenna with a plurality of feed signal connectors and ground terminals can be formed.

15. The chip antenna device according to claim 1, wherein the radiator body and ground radiator on said substrate can be extended so that a multi-band, single frequency chip antenna can be formed on the same substrate.
